(19) United States
(12) Patent Application Publication
(10) Pub. No.: US 2024/0409727 A1
(43) Pub. Date: Dec. 12, 2024

(54) Functional modification of reclaimed rubber materials and use thereof in making safety gloves

(71) Applicant: ZHEJIANG KANGLONGDA SPECIAL PROTECTION TECHNOLOGY CO., LTD., Shaoxing, Zhejiang (CN)

(72) Inventors: Jianfang ZHANG, Shaoxing, Zhejiang (CN); Ranasinghe Arachchige Don THAMIRA DILANTHA RANASINGHE, Shaoxing, Zhejiang (CN); Jiadi ZHANG, Shaoxing, Zhejiang (CN); Guohai LIU, Shaoxing, Zhejiang (CN)

(21) Appl. No.: 18/699,855

(22) PCT Filed: Nov. 21, 2023
(86) PCT No.: PCT/CN2023/132893

§ 371 Date: Apr. 9, 2024

(30) Foreign Application Priority Data
Sep. 27, 2022 (CN) 202211187009.9

(51) Int. Cl. C08L 9/02; A41D 19/00; A41D 19/015; C08K 5/529; C08L 17/00; C08L 75/04

(52) U.S. Cl. CPC C08L 9/02; A41D 19/0055; A41D 19/015; C08K 5/529; C08L 17/00; C08L 75/04; C08L 2205/025; C08L 2205/03; C08L 2207/20

(57) ABSTRACT

The present invention relates to the technical field of rubber materials, and discloses a functional modification of reclaimed rubber material and use thereof in making safety gloves, wherein by using the hyperbranched nitrile butadiene rubber-polyurethane as the filling and modification agent, mixing with the nitrile butadiene rubber and reclaimed nitrile butadiene rubber for modification, the hyperbranched polyurethane has three dimensional branched network structures, in the meanwhile, nitrile butadiene rubber molecular chains are contained in the main chains, so that the hyperbranched nitrile butadiene rubber-polyurethane, the nitrile butadiene rubber and the reclaimed nitrile butadiene rubber have good interface compatibility, and the hyperbranched nitrile butadiene rubber-polyurethane, the nitrile butadiene rubber and the reclaimed nitrile butadiene rubber form three-dimensional interlinking networks, so that the mechanical properties such as tensile strength and tear strength of the reclaimed rubber composite materials are improved.

### TECHNICAL FIELD

The present invention relates to the technical field of rubber materials, specifically functional modification of reclaimed rubber materials and use thereof in making safety gloves.

### BACKGROUND TECHNOLOGY

Protection articles such as safety protection gloves, protection clothing are widely used in the field of health and medical engineering, special engineering work and petrochemical projects; nitrile butadiene rubber has advantages such as good oil resistance and wear resistance, and has a wide prospect for use in the field of safety protection gloves, protective suits, and protective footwear, it is advantageous to improve overall performance of nitrile butadiene rubber, for example, mechanical and thermodynamic performance thereof, to extend actual application of nitrile butadiene rubber in protection articles such as gloves; for example, a Chinese patent no. CN1128912261B prepared a nitrile butadiene rubber-polyurethane composite gloves, wherein by attaching a layer of positive ion weak acid waterborne polyurethane film that is antibacterial and can conjugate to absorb ultraviolet lights over the nitrile butadiene rubber membrane, the gloves obtained are oil and weathering resistant, have good bacteria permeation resistance and are air and moisture permeable.

By filling and modifying the nitrile butadiene rubber with high molecular polymers the mechanical strength and aging resistance thereof can be enhanced, for example, in Antiaging Function of Dendrimer Polyamidoamine on Butadiene-Acrylonitrile Rubber, hyperbranched dendrimer polyamidoamine (PAMAM) were synthesized and added to the nitrile butadiene rubber as an antiaging agent, whereby the mechanical performance and antiaging performance of the nitrile butadiene rubber is improved; the present invention aims to synthesize hyperbranched nitrile butadiene rubber-polyurethane co-mixed and modified with NBR latex and reclaimed NBR to improve the mechanical performance and temperature resistance of rubber materials and expand development and use of NBR in making special protective articles such as safety gloves.

### SUMMARY OF THE INVENTION

### I. Technical Problems to be Solved

In view of deficiencies of the prior art, the present invention provides a functional modification of reclaimed rubber material for use in safety gloves, to address the problem that the mechanical performance and thermal resistance of glove materials of reclaimed nitrile composite rubber are not high enough.

### II. Technical Solutions

To realize the foregoing purpose, the present invention provides the following technical solutions: a functional modification method of reclaimed rubber materials, comprising:

S1: mixing nitrile butadiene rubber (NBR) 100 parts by weight, reclaimed nitrile butadiene rubber 15-35 parts by weight, hyperbranched nitrile butadiene rubber-polyurethane, dioctyl phthalate 20-40 parts by weight, adding to a mill mixer for calendering, adding stearic acid 0.5-1.2 parts by weight, anti deteriorant 0.6-1.5 parts by weight, milling evenly and adding cumyl peroxide 0.5-1 part by weight, triallyl isocyanurate 1-2 parts by weight for calendering, winding and sheeting to be milled rubber.

S2: vulcanizing the milled rubber in a vulcanizing press and obtaining the reclaimed rubber material after function modification.

Preferably, in S1, an amount of the hyperbranched nitrile butadiene rubber-polyurethane is 2-8% of a weight of the nitrile butadiene latex.

Preferably, vulcanizing conditions in S2 are that, vulcanizing press 8-12 MPa, vulcanizing treatment for 20-40 mins, and vulcanizing temperature 160-180° C.

Preferably, a preparation method of the hyperbranched nitrile butadiene rubber-polyurethane comprising:

S3: adding 2 aminoethoxy diphosphate and pentaerythritol and 4-(Chloromethyl)benzaldehyde to an ethanol solvent, mixing to dissolve and adding dropwise acetic acid glacial, heating until 65-80° C. to stir, refluxing and reacting for 6-18 h, after reaction, vacuumizing and condensing to remove the ethanol solvent, adding distilled water and ethyl acetate, standing for layering and extracting for separation, adding anhydrous sodium sulfate into organic layers for drying, filtering, collecting filtering liquid, vacuumizing, condensing and removing the ethyl acetate, washing wish ethyl ether, adding the product to the ethyl acetate for recrystallization, and obtaining di(chloromethyl benzamino phosphate and pentaerythritol).

S4: adding the di(chloromethyl benzamino phosphate and pentaerythritol) and diethanolameine into the solvent, heating until 50-70° C., reacting for 12-24 h, after reaction, vacuumizing, condensing and removing the ethanol solvent, washing with ethyl ether and adding the product to the ethanol for recrystallization, and obtaining di(diethanolameine benzamino phosphate and pentaerythritol).

S5: dehydrating in vacuum polyethylene glycol 100 parts by weight, dissolving toluene-2,4-diisocyanate 60-85 parts by weight and hydroxyl-terminated nitrile butadiene latex 30-55 parts by weight into N,N-Dimethylformamide, in N₂ atmosphere adding dropwise dibutyl tin laurate 0.3-0.6 parts by weight, heating to 75-85° C., cooling down until 50-60° C., adding the di(diethanolameine benzamino phosphate and pentaerythritol) 12-20 parts by weight, mixing for reaction for 1-3 h, after reaction, filtering the solvent, washing the product in sequence with distilled water and ethanol, and obtaining the hyperbranched nitrile butadiene rubber-polyurethane.

Preferably, in S3, a molar ratio of an amount of substance of the 2 aminoethoxy diphosphate and pentaerythritol and the 4-(Chloromethyl)benzaldehyde is 1:2.2-2.8. Preferably, in S3, an amount of the acetic acid glacial is 2-4% of a total weight of reaction substances.

Preferably, in S4, the solvent comprises any of ethyl acetate, tetrahydrofuran, methylbenzene and dimethylbenzene.

Preferably, in S4, a molar ratio of an amount of substance of the di(chloromethyl benzamino phosphate and pentaerythritol) and the diethanolameine is 1:2-2.4

### III. Beneficial Effects

Compared with the prior art, the present invention has the following beneficial effects:

By adding the 2 aminoethoxy diphosphate and pentaerythritol to react in turn with the 4-(Chloromethyl)benzaldehyde and the diethanolameine, hydroxy-functionalized di(diethanolameine benzamino phosphate and pentaerythritol) is synthesized as a branching and chain-extending agent for hyperbranched polyreaction with the hydroxyl-terminated nitrile butadiene latex, polyethylene glycol and toluene-2,4-diisocyanate, the hyperbranched nitrile butadiene latex-polyurethane containing bispirocyclic phosphate structures is synthesized.

Using the hyperbranched nitrile butadiene rubber-polyurethane as the filling and modification agent, mixing with the nitrile butadiene rubber and reclaimed nitrile butadiene rubber for modification, the hyperbranched polyurethane has three dimensional branched network structures, in the meanwhile, nitrile butadiene rubber molecular chains are contained in the main chains, so that the hyperbranched nitrile butadiene rubber-polyurethane, the nitrile butadiene rubber and the reclaimed nitrile butadiene rubber have good interface compatibility, and the hyperbranched nitrile butadiene rubber-polyurethane, the nitrile butadiene rubber and the reclaimed nitrile butadiene rubber form three-dimensional interlinking networks, so that the mechanical properties such as tensile strength and tear strength of the reclaimed rubber composite materials are improved.

The hyperbranched nitrile butadiene rubber-polyurethane has nitrile butadiene latex-polyurethane containing bispirocyclic phosphate structures which have high flame retardance and high thermal stability, the thermal decomposition temperature and the carbon-forming amount of the reclaimed rubber composite material are improved, higher thermal resistance is exhibited, and actual application of the reclaimed nitrile butadiene rubber composite material in special protection facilities such as safety gloves is extended.

### BRIEF DESCRIPTION OF DRAWINGS

FIG. 1 is a hydrogen nuclear magnetic resonance (H-NMR) spectroscopy of the di(chloromethyl benzamino phosphate and pentaerythritol) in embodiment 1.
FIG. 2 is a H-NMR spectroscopy of the di(diethanolameine benzamino phosphate and pentaerythritol) in embodiment 1.

FIG. 3 is an FT-IR spectroscopy of the hyperbranched nitrile butadiene rubber-polyurethane.

FIG. 4 is a TG curve of the reclaimed rubber material after function modification.

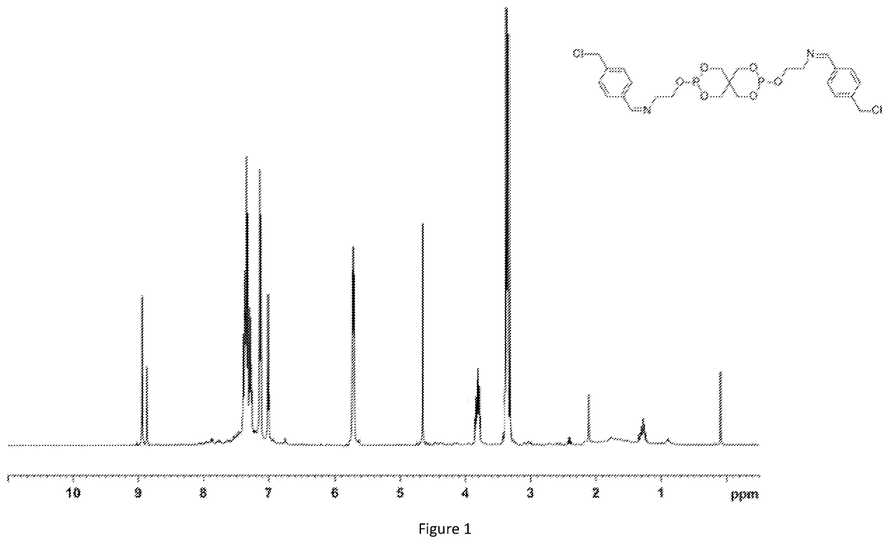

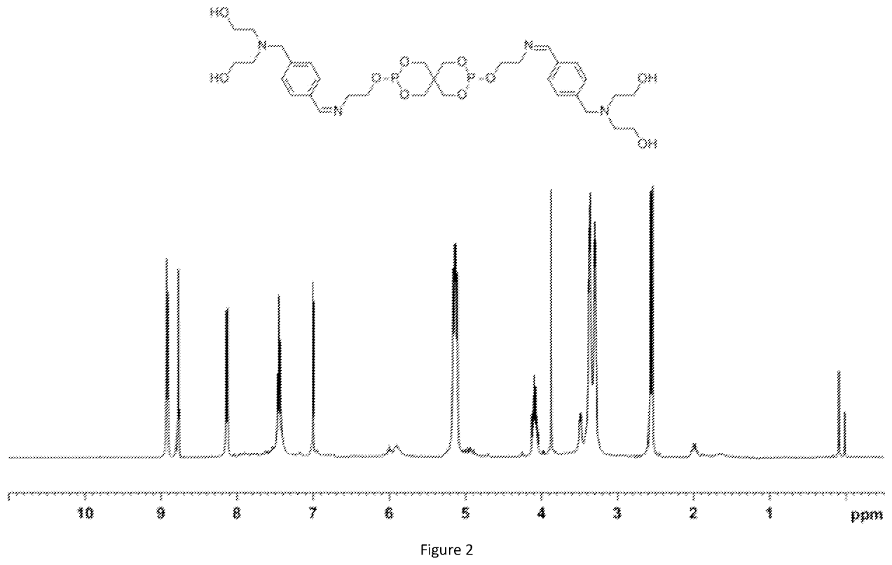

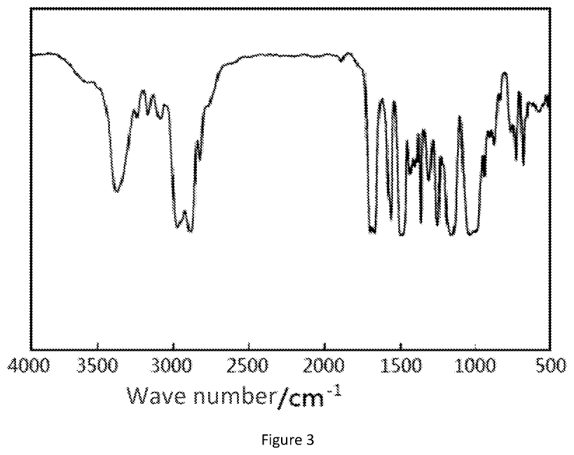

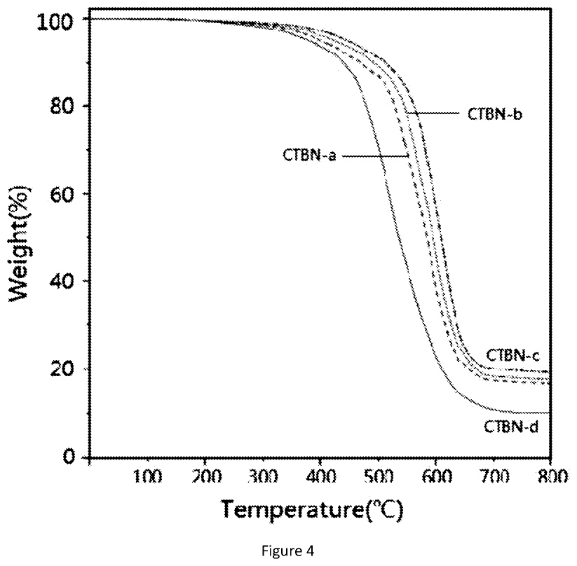

### EMBODIMENTS

Reclaimed nitrile butadiene rubber: code number 012; model 001; Hengshui Dehai Rubber Products Co., Ltd. Hydroxyl-terminated nitrile butadiene latex: model TL50; Jining Tangyi Chemical Co., Ltd.

Nitrile butadiene latex: solid content 44%; viscosity: 4500+2000 PCS; Jinan Xinling Chemical Technology Co., Ltd.

Polyethylene glycol: molecular weight 2000, no.: A040538; article no. A0405385000; Anhui Zesheng Technology Co., Ltd., Energy Chemical.

Acetic acid glacial: AR, ≥99.5%; article no. B0200525000; Anhui Zesheng Technology Co., Ltd., Energy Chemical.

Bisaminoethoxy pentaerythritol diphosphite was prepared as per the literature Synthesis of Bisaminoethoxy pentaerythritol diphosphite in Chemical Intermediates in Issue 3, 2012, article no.: T1672-8114 (2012) 03-044-05; triethyl phosphite 6.8 g, pentaerythritol 2.7 g and dibutyltin dilaurate (DBTL) 0.13 g were added to react for 3 h at 130° C., vacuumizing and distilling to remove ethanol byproducts, adding ethanolamine 3.2 g, reacting for 3 h at 140° C., after reaction, vacuumizing and distilling to obtain the bisaminoethoxy pentaerythritol diphosphite,

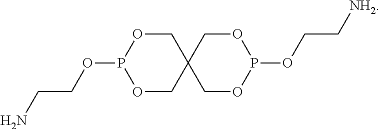 [SMILES: NCCOP1OCC2(CO1)COP(OCCN)OC2]

### Embodiment 1

(1) Adding bisaminoethoxy pentaerythritol diphosphite 2.5 g and 4-(Chloromethyl)benzaldehyde 3 g into an ethanol solvent 50 mL, stirring for mixing and adding dropwise glacial acetic acid 0.18 g, heating to 80° C., mixing, refluxing and reacting for 18 h, after reaction, vacuumizing for condensation and removing the ethanol solvent, adding distilled water and ethyl acetate, staying for layering and extracting and separating, adding anhydrous sodium sulfate into organic layers for drying, filtering and collecting filtrates, vacuumizing for concentration and removing the ethyl acetate solvent, washing with ethyl ether and adding the product into the ethyl acetate for recrystallization, and obtaining di(chloromethyl benzamino phosphate and pentaerythritol):

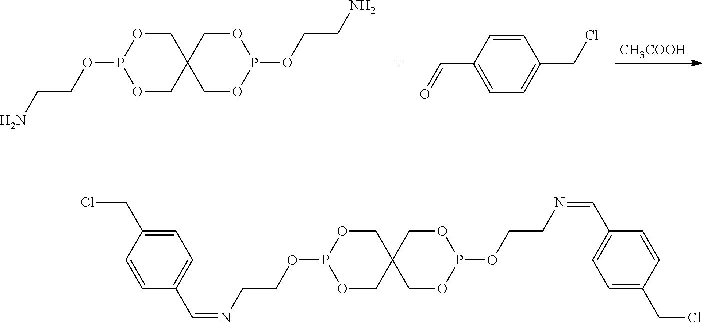

(2) Adding di(chloromethyl benzamino phosphate and pentaerythritol) 3 g and diethanolameine 1.2 g into tetrahydrofuran 100 mL, heating to 50° C., reaction, vacuumizing for condensation and removing the ethanol solvent, washing with ethyl ether and adding the product into the ethanol for recrystallization and obtaining di(diethanolameine benzamino phosphate and pentaerythritol);

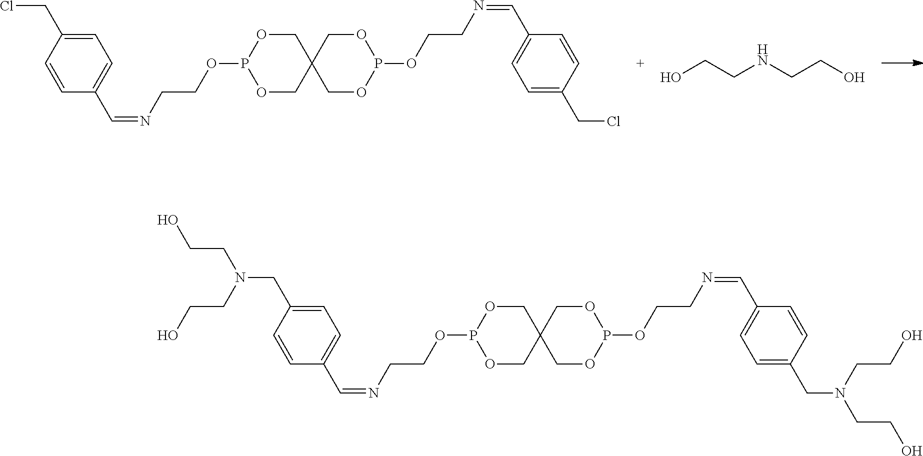 [SMILES: ClCc1ccc(/C=N\CCOP2OCC3(CO2)COP(OCC/N=C\c2ccc(CCl)cc2)OC3)cc1 ; OCCNCCO ; OCCN(CCO)Cc1ccc(/C=N\CCOP2OCC3(CO2)COP(OCC/N=C\c2ccc(CN(CCO)CCO)cc2)OC3)cc1]

(3) Dewatering in vacuum polyethylene glycol 5 g, dissolving the polyethylene glycol, toluene-2,4-diisocyanate 3 g and hydroxyl-terminated nitrile butadiene latex 1.5 g into N,N-Dimethylformamide 30 mL, adding dropwise dibutyl tin laurate 15 mg in N2 atmosphere, heating until 85° C., reacting for 2 h, cooling down to 50° C. and adding di(diethanolameine benzamino phosphate and pentaerythritol) 0.6 g, stirring and mixing for 3 h, reaction and filtering the solvent, washing the product with distilled water and ethanol sequentially, and obtaining hyperbranched nitrile butadiene rubber-polyurethane.
(4) Adding nitrile butadiene latex 20 g, reclaimed nitrile butadiene rubber 4.5 g, the hyperbranched nitrile butadiene rubber-polyurethane 0.4 g and dioctyl phthalate 4 g into a mill mixer for calendering, thereafter, adding stearic acid 0.1 g, bis(4-octylphenyl)amine 0.2 g, milling evenly and adding cumyl peroxide 0.15 g, triallyl isocyanurate 0.25 g for calendering, winding and sheeting to be milled rubber.
(5) Vulcanizing the milled rubber for 40 min at 160° C. and 12 MPa in a vulcanizing press and obtaining the functionally modified reclaimed rubber material CABN-a.

### Embodiment 2

(1) Adding the bisaminoethoxy pentaerythritol diphosphite 2.5 g and 4-(Chloromethyl)benzaldehyde 3.4 g into an ethanol solvent 50 mL, stirring for mixing and adding dropwise glacial acetic acid 0.11 g, heating to 65° C., mixing, refluxing and reacting for 18 h, after reaction, vacuumizing for concentration and removing the ethanol solvent, adding distilled water and ethyl acetate, staying for layering and extracting and separating, adding anhydrous sodium sulfate into organic layers for drying, filtering and collecting filtrates, vacuumizing for condensation and removing the ethyl acetate solvent, washing with ethyl ether and adding the product into the ethyl acetate for recrystallization, and obtaining di(chloromethyl benzamino phosphate and pentaerythritol);
(2) Adding the di(chloromethyl benzamino phosphate and pentaerythritol) 3 g and diethanolameine 1.3 g into ethyl acetate 50 mL, heating to 70° C., reaction for 12 h, vacuumizing for condensation and removing the ethanol solvent, washing with ethyl ether and adding the product into the ethanol for recrystallization and obtaining di(diethanolameine benzamino phosphate and pentaerythritol);
(3) Dewatering in vacuum polyethylene glycol 5 g, dissolving the polyethylene glycol, toluene-2,4-diisocyanate 3.8 g and hydroxyl-terminated nitrile butadiene latex 2.2 g into N,N-Dimethylformamide 80 mL, adding dropwise dibutyl tin laurate 25 mg in N₂ atmosphere, heating until 75° C., reacting for 3 h, cooling down to 60° C. and adding di(diethanolameine benzamino phosphate and pentaerythritol) 0.8 g, stirring and mixing for 3 h, reaction and filtering the solvent, washing the product with distilled water and ethanol sequentially, and obtaining hyperbranched nitrile butadiene rubber-polyurethane.
(4) Adding nitrile butadiene latex 20 g, reclaimed nitrile butadiene rubber 7 g, the hyperbranched nitrile butadiene rubber-polyurethane 1.2 g and dioctyl phthalate 7 g into a mill mixer for calendering, thereafter, adding stearic acid 0.24 g, N-Isopropyl-N′-phenyl-4-phenylenediamin 0.3 g, milling evenly and adding cumyl peroxide 0.2 g, triallyl isocyanurate 0.2 g for calendering, winding and sheeting to be milled rubber.
(5) Vulcanizing the milled rubber for 20 min at 180° C. and 8 MPa in a vulcanizing press and obtaining the functionally modified reclaimed rubber material CABN-b.

### Embodiment 3

(1) Adding the bisaminoethoxy pentaerythritol diphosphite 2.5 g and 4-(Chloromethyl)benzaldehyde 2.7 g into an ethanol solvent 30 mL, stirring for mixing and adding dropwise glacial acetic acid 0.11 g, heating to 80° C., mixing, refluxing and reacting for 18 h, after reaction, vacuumizing for condensation and removing the ethanol solvent, adding distilled water and ethyl acetate, staying for layering and extracting and separating, adding anhydrous sodium sulfate into organic layers for drying, filtering and collecting filtrates, vacuumizing for condensation and removing the ethyl acetate solvent, washing with ethyl ether and adding the product into the ethyl acetate for recrystallization, and obtaining di(chloromethyl benzamino phosphate and pentaerythritol);
(2) Adding the di(chloromethyl benzamino phosphate and pentaerythritol) 3 g and diethanolameine 1.1 g into methylbenzene 50 mL, heating to 50° C., reaction for 18 h, vacuumizing for condensation and removing the ethanol solvent, washing with ethyl ether and adding the product into the ethanol for recrystallization and obtaining di(diethanolameine benzamino phosphate and pentaerythritol);
(3) Dewatering in vacuum polyethylene glycol 5 g, dissolving the polyethylene glycol, toluene-2,4-diisocyanate 4.2 g and hydroxyl-terminated nitrile butadiene latex 2.7 g into N,N-Dimethylformamide 80 mL, adding dropwise dibutyl tin laurate 30 mg in N₂ atmosphere, heating until 75° C., reacting for 3 h, cooling down to 55° C. and adding di(diethanolameine benzamino phosphate and pentaerythritol) 1 g, stirring and mixing for 1 h, reaction and filtering the solvent, washing the product with distilled water and ethanol sequentially, and obtaining hyperbranched nitrile butadiene rubber-polyurethane.
(4) Adding nitrile butadiene latex 20 g, reclaimed nitrile butadiene rubber 6 g, the hyperbranched nitrile butadiene rubber-polyurethane 1.6 g and dioctyl phthalate 7.5 g into a mill mixer for calendering, thereafter, adding stearic acid 0.1 g, N-Isopropyl-N′-phenyl-4-phenylenediamin 0.25 g, milling evenly and adding cumyl peroxide 0.14 g, triallyl isocyanurate 0.32 g for calendering, winding and sheeting to be milled rubber.
(5) Vulcanizing the milled rubber for 30 min at 170° C. and 10 MPa in a vulcanizing press and obtaining the functionally modified reclaimed rubber material CABN-c.

### Comparative Example 1

(1) Adding nitrile butadiene latex 20 g, reclaimed nitrile butadiene rubber 4.6 g and dioctyl phthalate 5.2 g into a mill mixer for calendering, thereafter, adding stearic acid 0.2 g, bis(4-octylphenyl)amine 0.18 g, milling evenly and adding cumyl peroxide 0.15 g, triallyl isocyanurate 0.27 g for calendering, winding and sheeting to be milled rubber.
(2) Vulcanizing the milled rubber for 20 min at 180° C. and 8 MPa in a vulcanizing press and obtaining the functionally modified reclaimed rubber material CABN-d.

Tensile performance test: making the functionally modified reclaimed rubber material to be strips of 10 cm×3 cm×0.5 cm, and testing the extension performance with a universal electro-mechanical testing machine and the tensile rate was measured to be 10 mm/min.

Thermogravimetric analysis: making the functionally modified reclaimed rubber material to be square test pieces of 2 cm×2 cm×0.3 cm, conducting thermogravimetric analysis by a thermogravimetric analyzer in nitrogen atmosphere, heating the room temperature 20° C. to 800° C. at a heating rate of 10° C./min.

Shore A hardness test: measuring the Shore A hardness of the functionally modified reclaimed rubber material with a rubber hardness tester, the test pieces are 5 cm×2 cm×0.6 cm, when the test pieces were subjected to a load of a 1 kg force, reading the value when a bottom surface of the hardness tester smoothly joined surfaces of the test pieces.

Fracturing strength test: measuring a tearing strength of the functionally modified reclaimed rubber material by a tensile testing machine and applying a trouser tearing method, wherein a tensile rate of the trouser shaped test piece is 100 mm/min and a depth of a cut of the test piece: 50 mm.

| | Tensile | Elongation | Shore A | Tearing |
|---|---|---|---|---|
| Test | strength | at break | hardness | strength |
| piece | (MPa) | (%) | (° C.) | (kN/m) |
| CABN-a | 23.7 | 462.1 | 74 | 42 |
| CABN-b | 31.2 | 380.2 | 78 | 48 |
| CABN-c | 27.0 | 427.0 | 70 | 46 |
| CABN-d | 20.1 | 361.8 | 67 | 38 |

CABN-a, b, c are the functionally modified reclaimed rubber material prepared as per embodiments 1-3 and CABN-d is the reclaimed rubber material prepared in the comparative example 1.

1. A functional modification method of reclaimed rubber materials, comprising:
(step 1): mixing nitrile butadiene rubber (NBR) 100 parts by weight, reclaimed nitrile butadiene rubber 15-35 parts by weight, hyperbranched nitrile butadiene rubber-polyurethane, dioctyl phthalate 20-40 parts by weight, adding to a mill mixer for calendering, adding stearic acid 0.5-1.2 parts by weight, anti deteriorant 0.6-1.5 parts by weight, milling evenly and adding cumyl peroxide 0.5-1 part by weight, triallyl isocyanurate 1-2 parts by weight for calendering, winding and sheeting to be milled rubber;
(step 2): vulcanizing the milled rubber in a vulcanizing press and obtaining the reclaimed rubber material after function modification.

2. The functional modification method of reclaimed rubber materials according to claim 1, wherein in (step 1), an amount of the hyperbranched nitrile butadiene rubber-polyurethane is 2-8% of a weight of the nitrile butadiene latex.

3. The functional modification method of reclaimed rubber materials according to claim 1, wherein vulcanizing conditions in (step 2) are that, vulcanizing press 8-12 MPa, vulcanizing treatment for 20-40 mins, and vulcanizing temperature 160-180° C.

4. The functional modification method of reclaimed rubber materials according to claim 1, wherein a preparation method of the hyperbranched nitrile butadiene rubber-polyurethane comprising:
(step 3): adding 2 aminoethoxy diphosphate and pentaerythritol and 4-(Chloromethyl)benzaldehyde to an ethanol solvent, mixing to dissolve and adding dropwise acetic acid glacial, heating until 65-80° C. to stir, refluxing and reacting for 6-18 h, after reaction, vacuumizing and condensing to remove the ethanol solvent, adding distilled water and ethyl acetate, standing for layering and extracting for separation, adding anhydrous sodium sulfate into organic layers for drying, filtering, collecting filtering liquid, vacuumizing, condensing and removing the ethyl acetate, washing wish ethyl ether, adding the product to the ethyl acetate for recrystallization, and obtaining di(chloromethyl benzamino phosphate and pentaerythritol);
(step 4): adding the di(chloromethyl benzamino phosphate and pentaerythritol) and diethanolameine into the solvent, heating until 50-70° C., reacting for 12-24 h, after reaction, vacuumizing, condensing and removing the ethanol solvent, washing with ethyl ether and adding the product to the ethanol for recrystallization, and obtaining di(diethanolameine benzamino phosphate and pentaerythritol);
(step 5): dehydrating in vacuum polyethylene glycol 100 parts by weight, dissolving toluene-2,4-diisocyanate 60-85 parts by weight and hydroxyl-terminated nitrile butadiene latex 30-55 parts by weight into N,N-Dimethylformamide, in N₂ atmosphere adding dropwise dibutyl tin laurate 0.3-0.6 parts by weight, heating to 75-85° C., cooling down until 50-60° C., adding the di(diethanolameine benzamino phosphate and pentaerythritol) 12-20 parts by weight, mixing for reaction for 1-3 h, after reaction, filtering the solvent, washing the product in sequence with distilled water and ethanol, and obtaining the hyperbranched nitrile butadiene rubber-polyurethane.

5. The functional modification method of reclaimed rubber materials according to claim 1, wherein in (step 3) a molar ratio of an amount of substance of the 2 aminoethoxy diphosphate and pentaerythritol and the 4-(Chloromethyl)benzaldehyde is 1:2.2-2.8.

6. The functional modification method of reclaimed rubber materials according to claim 1, wherein in (step 3), an amount of the acetic acid glacial is 2-4% of a total weight of reaction substances.

7. The functional modification method of reclaimed rubber materials according to claim 1, wherein in (step 4), the solvent comprises any of ethyl acetate, tetrahydrofuran, methylbenzene and dimethylbenzene.

8. The functional modification method of reclaimed rubber materials according to claim 1, wherein in (step 4), a molar ratio of an amount of substance of the di(chloromethyl benzamino phosphate and pentaerythritol) and the diethanolameine is 1:2-2.4.
